(19) United States
(12) Patent Application Publication
(10) Pub. No.: US 2024/0211889 A1
(43) Pub. Date: Jun. 27, 2024

(54) PLATFORM FOR CONNECTING EMPLOYERS AND CANDIDATES

(71) Applicant: Egtos GmbH, Worcester, MA (US)

(72) Inventor: Adu OPOKU-BOAHIN, Worcester, MA (US)

(21) Appl. No.: 18/601,775

(22) Filed: Mar. 11, 2024

(51) Int. Cl. G06Q 10/1053; G06Q 50/00

(52) U.S. Cl. CPC G06Q 10/1053; G06Q 50/01

(57) ABSTRACT

The disclosed invention provides for an Internet-based platform and related service to connect employers with candidates. The platform includes a database of employer profiles and candidates profiles, and an Internet-based communication channel between employers and candidates. In some embodiments, the platform presents candidates to employers based on index scores and purpose-alignment scores. In some embodiments, the platform shares excess availability of one employer's employees with another employer. In some embodiments, the platform generates a team of experts through a combination of employees and contractors. In some embodiments, the platform uses tokenized payment methods for exchanging and purchasing candidate resources. In some embodiments, the platform generates and presents a news feed to first candidates and employers comprising posts by second candidates and employers in which such first candidates and employers are connected.

### TECHNICAL FIELD

The present disclosure relates in general to the field of social-network-based platforms and processes, and more particularly to a platform and related service for connecting employers with job candidates across two or more devices in a network.

### BACKGROUND

People use online platforms to network and communicate with other people because of the advantages that online platforms have over in-person networking and communication. For example, through the use of electronic devices, like laptops and smartphones, a user can connect with several people, located in different geographical zones, based on shared interests or characteristics, without having to commute or to ask each person whether they share an interest or characteristic. Common networking platforms today include Instagram™, Facebook™, and LinkedIn™.

Some online platforms also provide services to help connect employers and job candidates. For example, a platform called ZipRecruiter™ provides an employment marketplace where employers can post available jobs, and employees can apply to those jobs.

The existing online employment marketplace platforms provide technological improvements over in-person employment marketplaces (e.g., job fairs). For example, the online marketplaces allow users to view a much larger number of job openings than can be present at one or even dozens of job fairs. Additionally, the use of computer technology allows an applicant to filter the job postings so the applicant does not need to review each available job posting. The existing online employment marketplace platforms also streamline the application process, by allowing applicants to submit a keyword-searchable version of their resumes, instantly and directly, to employers. The existing online employment marketplace platforms also allow employees to view additional information about an employer or a job posting through a simple click of a button.

There are many needs in online networks and in online employment marketplaces that can be addressed through advances in technology. There exists a need to make online networking even more efficient, stream-lined, and user-friendly. There exists a need to further improve the mechanisms by which employers and job applicants are introduced and connected online. There exists a need for a platform that accounts for factors with higher relevance to creating strong connections. There exists a need for a platform that provides users with information that improves their ability to make decisions in an online marketplace. There exists a need to increase the number of qualified job applicants available to an employer, while reducing the number of unqualified job applicants an employer must review to find such qualified applicants. Solutions to these problems are not obvious.

The invention disclosed in this specification adds technological advances to existing social media platforms and online employment marketplaces to solve needs in these high-tech industries.

### SUMMARY

The disclosed invention provides for an Internet-based platform and related service to connect employers with candidates. The platform may include a database of employer profiles and candidates profiles, and an Internet-based communication channel between employers and candidates. In some embodiments, the platform presents candidates to employers based on index scores and purpose-alignment scores. In some embodiments, the platform shares excess availability of one employer's employees with another employer. In some embodiments, the platform generates a team of experts through a combination of employees and contractors. In some embodiments, the platform uses tokenized payment methods for exchanging and purchasing candidate resources. In some embodiments, the platform generates and presents a news feed to first candidates and employers comprising posts by other candidates and employers in which such first candidates and employers are connected.

In some embodiments, a platform for connecting employers with candidates may comprise a database storing a profile for a first employer, a profile for a second employer, a profile for a first candidate, and a profile for a second candidate. The first candidate may be employed by the first employer, and the second candidate may be employed by the second employer. The profile for the first candidate may comprise an index score and purpose information. The platform may also comprise one or more processors in communication with the database and two or more user devices, wherein the one or more processors perform various steps. The steps may include receiving a project from the second employer, wherein the project specifies a need of the second employer for one or more candidates; generating, based on the specified need and the index score, a team that comprises the first candidate and the second candidate; generating a purpose-alignment score based on the profile for the second employer and the purpose information; presenting to the second employer, based on the generated team, the index score and the purpose-alignment score in association with information identifying the profile for the first candidate; receiving, from the second employer, a selection of the team; and providing, based on the selection of the team, an Internet-based communication channel between the second employer and the first candidate in association with the project.

In some embodiments, a platform for connecting employers with candidates may comprise a database for storing one or more candidate profiles and one or more employer profiles. The platform may also comprise one or more processors in communication with the database and two or more user devices. The one or more processors perform various steps. The steps may include receiving background information and purpose information corresponding to a candidate. The steps may include generating an index score based on the received background information. The steps may include storing, in the database, a candidate profile corresponding to the candidate and containing the index score, the background information, and the purpose information. The steps may include receiving, from an employer, employer information containing one or more characteristics of the employer. The steps may include storing, in the database, an employer profile corresponding to the employer and containing the employer information. The steps may include generating, based on the candidate's purpose information and the employer information, a purpose-alignment score. The steps may include presenting, to the employer, the index score and the purpose-alignment score. The steps may include receiving, from the employer, a request to connect with the candidate. The steps may include providing an Internet-based communication channel between the employer using a first user device and the candidate using a second user device.

In some embodiments, the platform may perform steps comprising presenting, to the employer, a second index score and a second purpose-alignment score, each corresponding to a second candidate; receiving, from the employer, an indication to not select the second candidate; and not providing an Internet-based communication channel between the employer and the second candidate.

In some embodiments, the platform may perform steps comprising receiving, from the candidate, a request to follow the employer; receiving, from the employer, a content; and presenting, to the candidate, the content.

In some embodiments, the platform may perform steps comprising storing a signed employment agreement corresponding to an employment relationship between the employer and the candidate, wherein the Internet-based communication channel facilitates the candidate's performance of a task as part of the employment relationship.

In some embodiments, the Internet-based communication channel is used by the employer to interview the candidate.

In some embodiments, the purpose-alignment score is generated based on similarity vectors between aspects of the purpose information and aspects of the employer information. In some embodiments, the index score is generated based on a machine-learning model.

In some embodiments, the platform may perform steps comprising receiving, from the employer, a project, wherein: the project specifies a need of the employer for one or more candidates; the presenting of the index score and purpose-alignment score to the employer is based on a match between the candidate profile and the need for one or more candidates; and the Internet-based communication channel allows the employer and the candidate to send, between each other, one or more documents and messages that are related to the project.

In some embodiments, the platform may perform steps comprising performing a background check for the candidate, including an automated evaluation of a reference associated with the candidate profile, wherein the automated evaluation includes determining, from a profile associated with the reference: a relationship between the reference and the candidate, and a level of seniority of the reference.

In some embodiments, the presenting of the index score and the purpose-alignment score to the employer is based on at least one of the index score and the purpose-alignment score, independently or in combination, exceeding a threshold value.

In some embodiments, the generating of the purpose-alignment score is based on the index score exceeding a threshold, and at least one of the candidate applying for a position with the employer, or the employer requesting more information about the candidate.

In some embodiments, a platform for connecting employers with candidates may comprise a database storing a profile for a first employer, a profile for a second employer, a profile for a first candidate, and a profile for a candidate, wherein the first candidate is primarily employed by the first employer. The platform may also comprise one or more processors in communication with the database and two or more user devices, wherein the one or more processors perform various steps. The steps may include receiving, from the second employer, a project, wherein the project specifies a need of the second employer for one or more candidates; generating, based on the received project, a team that includes the first candidate and the second candidate; presenting, to the second employer on a display of a first user device, the team; receiving, from the second employer, a selection of the team; and providing an Internet-based communication channel between the second employer using the first user device and the first candidate using a second user device based on the selection of the team comprising the first candidate, wherein the communication channel allows the second employer and the first candidate to send, between each other, one or more documents and messages that are related to the project.

In some embodiments, the second candidate is primarily employed by the second employer.

In some embodiments, the platform may perform steps comprising receiving, from the first candidate, a request to follow the second candidate; receiving, from the second candidate, a content; and presenting, to the first candidate, the content.

In some embodiments, the platform may perform steps comprising storing a signed employment agreement corresponding to an employment relationship between the second employer and the candidate, wherein the Internet-based communication channel facilitates the candidate's performance of a task as part of the employment relationship.

In some embodiments, the generating the team is based on a budget of the second employer, one or more requirements of the project, and one or more preferences of the second employer; and the generating the team includes an allocation of time for the project between the first candidate and the second candidate.

In some embodiments, the platform may perform steps comprising receiving, from the second employer, a milestone associated with the project; presenting, to the first employer, a status of the project based on the milestone not being completed; receiving, from the second employer, an indication that the milestone is completed; and presenting, to the first employer, an updated status of the project based on the completion of the milestone.

In some embodiments, the platform may perform steps comprising receiving electronic payment information associated with the second employer; associating with the second employer, based on the received electronic payment information, a first quantity of platform-based currency; in response to the selection of the team comprising the first candidate, reducing the first quantity of platform-based currency associated with the second employer by an amount; and associating, with the first employer, a second quantity of platform-based currency, wherein the second quantity is less than or equal to the amount.

In some embodiments, the platform may perform steps comprising receiving, from the first employer, a number of available hours associated with the first candidate. In some embodiments, the presenting, to the second employer, of the team includes the number of available hours.

### BRIEF DESCRIPTION OF THE DRAWINGS

For a more complete understanding of the present invention and its advantages, reference is now made to the following description and the accompanying drawings, in which:

FIG. 1 is a diagram that depicts an overview of one or more embodiment of the invention;

FIGS. 2-12 are flowcharts of steps performed by the platform in various embodiments of the invention;

FIG. 13 is a diagram that depicts a candidate profile as may be seen by an employer;

FIG. 14 is a diagram that depicts a job posting as may be seen by a candidate;

FIG. 15 is a diagram that depicts a set of job postings;

FIG. 16 is a diagram that depicts roles open for an employer;

FIGS. 17-18 are diagrams that depict candidates presented to an employer; and

FIG. 19 is a diagram that depicts two teams generated by the platform.

### DETAILED DESCRIPTION

The following detailed description includes exemplary embodiments of the disclosed invention. The figures illustrate some of those embodiments. The term “may” in relation to a feature described in this specification indicates that the feature can be present in some embodiments, and can be omitted in other embodiments: “may” is used to describe an example that might be present in some embodiments. If an optional feature includes multiple components, each component can be independently included in an embodiment unless the specification indicates that two or more of the components must be coupled together. The term “or” in a string of two or more options means “and/or” unless the context indicates otherwise: the term “or,” when joining a string of two or more options, indicates that a combination of one or more of the options can be selected for an embodiment.

The invention disclosed in this specification may improve upon existing online networking platforms by generating and providing numbers that serve as indicators for qualitative information. For example, the invention may include computer-generation of index scores and purpose-alignment scores to better inform employers and applicants of their compatibility. Providing scores instead of paragraphs of information can save time for both the employers and the applicants, and can result in stronger connections. The index score may be a number that represents an applicant's employment and education background, or other characteristics of the applicant that are relevant for employment. The purpose-alignment score may represent a cultural fit between an employee and an employer. Instead of reviewing each applicant's employment and education background, the employer can filter out applicants based on an index score of each applicant. Instead of hiring employees that aren't a good cultural fit for a position, an employer can remove candidates from an applicant pool without needing to interview each one—the employer can make decisions based simply on a purpose-alignment score.

The invention disclosed in this specification may improve upon existing online networking platforms by allowing employers to share employees with other employers. For example, if an employer only has enough work in November to keep an employee busy 20 hours per week, the employer can offer the employee to a second employer for a separate 20 hours per week during November. The platform can facilitate this process by allowing employers to hire candidates based on a network connection with the candidate's primary employer and a network connection with the candidate. The platform can provide a channel for a secondary employer to pay a primary employer for use of the primary employer's employee. The platform can also provide a channel for the secondary employer to communicate with the employee directly, and to communicate messages and documents with them. The platform can also communicate information between all parties (the primary employer, the secondary employer, and the employee), including a status of a project the employee is retained on. The platform may update the status of a project based, for example, on documents transmitted across the platform or indications made by one of the parties. Importantly, efficiently sharing resources between employers may be too complicated to be performed without the use of an online platform, and online platforms may allow for this new form of networking between employers to spread rapidly.

The invention disclosed in this specification may further improve the sharing of resources in an online environment by converting payment into a platform-specific currency. Based on the online nature of remote work, employers may be located in different locations from employees and other employers in which they interact. Various employers and employees in a network may use different currencies (e.g., USD, CNY, CAD, EUR, CHF, GBP). In some embodiments of this invention, employers may purchase a platform-specific currency, employers may pay for services of employees through that currency, and employers and employees may convert the platform currency in their platform account back into their native currency before extracting it from the platform. This allows users of the platform pay for services of employees with speed and ease since they do not need to, themselves, do mathematical conversions (based on a constantly changing relationships) between currency types. This also allows users to make payment through the platform, rather than through a different payment channel, which improves the user experience.

The invention disclosed in this specification may further improve the sharing of resources in an online environment by tokenizing payments. In some embodiments, a platform currency may be tokenized and stored on a blockchain to further improve user experience. For example, a blockchain-based contract may be created whereby payment from a secondary employer is to be made to a primary employer when the employee submits a requested document through the system. In that example, the receipt of the document by the platform, in transmitting the document between the employee and the secondary employer, automatically triggers the condition in the blockchain contract and immediately causes tokens to be transferred to the primary employer.

The invention disclosed in this specification may improve upon existing online networking platforms by using blockchain technology to authenticate an employer's ownership of an employee's work product. For example, documents sent from an employee to an employer as part of an employment contract can be saved in a database of the platform, located between the employee and employer in the network, and an identification of such documents can be stored on a blockchain when transmitted by the employee. This use of blockchain technology to authenticate electronic document transfers can help the employer, for example, in subsequent litigation against the employee or against one of the employee's other employers. The fact that blockchain technology can carry out authentication and performance of electronic contracts without human involvement increases the reliability, security, and speed of the processes.

The invention disclosed in this specification may improve upon existing online networking platforms by generating a team for a project. Generating a team of candidates may require hiring one or more candidates based on how those one or more candidates would contribute to each other or to existing members of the team based on each person's potential to contribute. Generating a team of candidates may be even more complicated if it involves combining candidates within the employer's company and candidates outside the employer's company. For example, the platform may generate a team of candidates that includes employees primarily employed by the employer and contractors primarily working for a different employer. Generating a team of candidates for a project benefits an employer because it allows the employer to select candidates for a job based on the compatibility of that candidate with other candidates with whom that candidate will work, and allows more than one candidate to be selected at a time while accounting for that compatibility. Accounting for candidates within and outside of an employer's network allows an employer to benefit from utilizing its existing resources while simultaneously becoming open to additional resources.

The invention disclosed in this specification may improve upon existing online networking platforms by optimizing a team of candidates. For example, the generation of a team may include optimizing for factors including the candidates' hourly rate, expertise, experience, location, and availability. Optimization of a team may improve the quality of the selected team based on how candidates' characteristics complement one another.

The invention disclosed in this specification may improve upon existing online networking platforms by optimizing the amount of time each selected candidate may be utilized for in a project. In some embodiments, the generation of a team may include—in addition to selection of candidates—an allocation of time between candidates based on the optimized factors. For example, one candidate may be allocated 30 hours to get the project started, while another two candidates divide the remaining work for a task associated with the project at a 65/35 split, based on expertise, location, hourly rate, and availability. This time allocation may occur simultaneous with candidate selection such that a team is selected to work best to complete a project through the candidates' varying benefits (ability to contribute) and the candidates' varying costs (e.g., hourly rate, time zone, need for training, and hours available). Time allocation when selecting a candidate may improve the quality of a selected team.

The invention disclosed in this specification may improve upon existing online networking platforms by accounting for a large number of candidates when generating a team for a project. For example, the number of candidates to select from for a team may be large: for example, exceeding 100, exceeding 1000, or even exceeding 100,000. Generating a team based on multiple factors, especially where the number of potential candidates is large, is impractical or impossible to accomplish without computer generation. Optimizing the team, including both selecting candidates and allocating time on the project between candidates, makes this problem even more complicated.

The invention disclosed in this specification may improve upon existing online networking platforms by providing an environment that allows candidates to network with other candidates, or with employers, in the context of seeking a particular job or jobs on the platform. For example, someone applying for a job at company A might connect with someone else who is applying for the same role, or someone who is currently in that role, and may view that person's posts on the platform related to that role. That someone might also want to follow company A on the platform to be kept up-to-date on changes with the company's mission, with the company's job postings, or with other changes the company thinks job applicants might want to hear.

The invention disclosed in this specification may improve upon existing online networking platforms by providing an environment in which employees and employers can communicate, sign agreements, and submit assignments, all without leaving the platform in which they were introduced. By requiring a user to leave a platform after being introduced or hired, for any purpose, the user experience is diminished. Integrating all of the functionality an employee or employer may need into one platform, or close to it, is a technological feat based on the mechanisms employed for integrating that functionality. For example, through the use of third-party APIs (i.e., application programming interfaces), an employer can sign documents, run background checks, utilize word-processing tools, view profiles, filter job applications, filter candidates, send messages, and send payments, all within the same interface, with the potential of not needing to log into additional services.

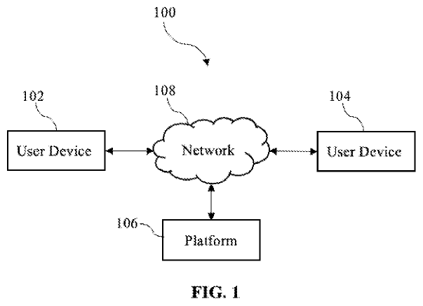

Turning to the figures, FIG. 1 is a diagram 100 that depicts an overview of one or more embodiment of the invention. The diagram 100 shows a platform 106 communicating with two user devices 102, 104 through a network 108. The network 108 in some embodiments may be a LAN or WAN. Optimally, the network 108 is the Internet. User devices 102, 104 may access the platform 106 through the network 106. The user devices 102, 104 may be electronic devices such as computers or smartphones. The user devices 102, 104 may be operated by a job candidate or an employer. The platform 106 may present content to the user devices 102, 104 through a webpage or an application. The platform 106 may comprise a database for storing electronic information, and one or more processors for processing that electronic information or performing one or more steps.

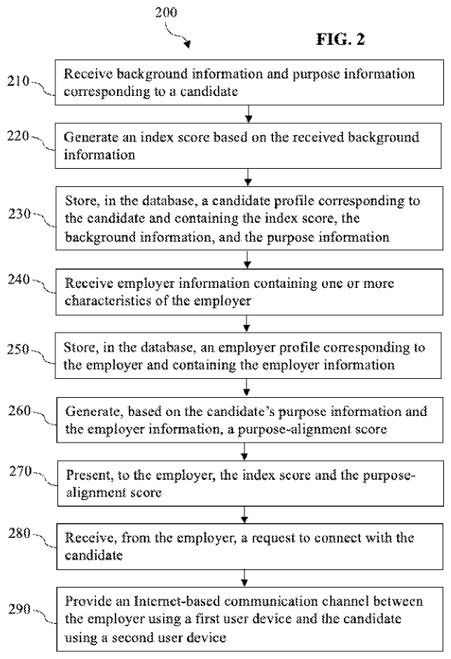

FIG. 2 is a flowchart 200 of steps performed by the platform in various embodiments of the invention. The flowchart 200 relates to presenting, to an employer, scores corresponding to a candidate, where those scores might help the employer decide whether to interview or hire the candidate. The flowchart 200 includes generating an index score and a purpose-alignment score in relation to a candidate, presenting those scores to an employer in relation to the candidate, and receiving a request from the employer to connect with the candidate.

As illustrated, the flowchart 200 begins at step 210 with receiving background information and purpose information corresponding to a candidate. A “candidate” refers to a job candidate; a person who is currently employed or open to becoming employed. The term “candidate” is broader than the term “job applicant” because “applicant” implies that the person has applied for a job, while a candidate may merely be a person who is open to a job or already has a job (e.g., a candidate may be someone who the employer reaches out to about a job).

A candidate may be in a pool of other candidates, and may be available for primary employment or secondary employment. A candidate's primary employer is the employer that forms the greatest foundation for the candidate: this may be based on many factors, such as which employer the employee worked with first; which employer the employee is considered full-time for; which employer pays the employee on a long-term or salary basis, rather than hourly, contract, or project-basis. A candidate's secondary employer may be defined in relation to the candidate's primary employer. A candidate may have more than one primary employer or more than one secondary employer. A candidate may be available for employment on a full-time, part-time, long-term, temporary, or contract basis.

Background information relates to the candidate's credentials and suitability for employment. Background information may include a candidate's current or desired job or industry. Background information may include skills of a candidate, such as Javascript, Python, or C++ for a software engineer. Background information may include employment history, education history, one or more references (other people who can be contacted to provide feedback about the candidate), personality characteristics, whether the candidate is able to work, the number of hours the candidate is available to work, or other information relevant to a candidate's employability. Employment history may include the jobs a candidate had in the past, the candidate's role at those jobs, the amount of time the candidate spent at those jobs, the amount a candidate was paid at those jobs, or one or more references corresponding to each job. Education history may include the schools a candidate attended, whether the candidate finished his/her degree program at those schools, which degrees the candidate received, when the candidate received those degrees, what GPA the candidate attained for those degrees, or other information relating to the candidate's educational background. Whether a candidate is able to work may be geographically-dependent (e.g., a green card or work visa may be required for a candidate to work in some countries).

The personality characteristics may be determined through application of a computer model to written or verbal statements by or relating to a candidate. The personality characteristics may be determined based on a video of the candidate, which may include an evaluation of the candidate's statements in the video or an evaluation of the candidate's communication skills. Evaluation of statements in a video may be achieved through speech recognition, speech-to-text conversion, application of a large language model (LLM) to the text, or application of a machine-learning (ML) model trained on statements and scores of previous candidates (i.e., through a supervised machine-learning model).

The personality characteristics may be determined through a third-party service that is linked to the platform through a third-party application program interface (API). For example, a candidate may provide responses to questions, a third-party service may evaluate the responses, and the third-party service may provide one or more numbers or characteristics to the platform for use in evaluating a candidate's suitability for employment. For example, the service may provide a single overall value for a candidate on a 1-100 scale; a set of several values, each relating to a different characteristic for the candidate; or a set of qualitative characteristics that are positive or negative for the candidate. An example output sent from a third-party service to the platform may include scores based on achievement, assertiveness, competitiveness, conscientiousness, cooperativeness, extroversion, managerial, motivation, openness, patience, self-confidence, or stress tolerance. Another example output sent from a third-party service to the platform may include scores based on spatial reasoning, verbal ability, or math and logic. The scores may be based on percentiles relative to a set of other people taking the same test, where 50 out of 100 is average, and the scores are on a bell curve. The percentiles may be industry specific, with the candidate's responses being compared specifically to people with the same job title or industry as the candidate. In some embodiments, the functions described as being performed by a third-party service, and integrated into the platform through an API, may be performed by the platform itself without the involvement of a third party.

Purpose information relates to a candidate's culture, motivations, and employment desires. Purpose information is helpful for finding a good culture fit between a candidate and an employer. Purpose information may include quantitative or qualitative information. For example, purpose information may include that a candidate desires to have moderate work-life balance, is motivated by impact more than by money, or is looking for a job that offers a lot of training. Similarly, purpose information could include that a candidate scores 5 on a 1-10 scale for an office-pace category, scores 7 for a purpose-driven category, or scores 9 for a role-training category. The inputs for purpose information may come from a video of a candidate or a questionnaire answered by the candidate.

Purpose information may be determined through application of a computer model to written or verbal statements by or relating to a candidate, similar to personality characteristics. For example, purpose information may implement supervised ML models to determine how a well a candidate fits into various predetermined purpose categories relative to other people. In some embodiments, categories may not be predetermined: in such embodiments, unsupervised ML models may be implemented to come up with clusters for an applicant on various axes, and characteristics of those clusters (e.g., location, concentration) may be used to compare applicants.

The flowchart 200 moves to step 220 with generating an index score based on the received background information. An “index score” is a number that relates to a candidate's background and suitability for employment generally. It accounts for background information, which may include employment and educational backgrounds of a candidate. The index score may provide an advantage in quickly representing to an employer whether a candidate is likely to be qualified for a job posting.

Inputs for the generation of the index score may be quantitative. For example, as described above, a personality characteristic may be a numerical value representing an applicant's percentile. Similarly, quantitative data may be derived through a machine-learning model trained on qualitative data as inputs and quantitative data as outputs.

Inputs for the generation of the index score may be qualitative. Qualitative data can include information like “bachelor's degree,” “highly cooperative,” or “highly assertive.” Qualitative or quantitative data may be provided through rule-based evaluation of data related to a candidate (e.g., answers to questionnaires), or may be provided through application of LLMs or other ML models. The inputs for the generation of the index score may also be a combination of qualitative and quantitative.

Data may be converted between quantitative and qualitative domains through pre-defined rules, through LLMs, or through other ML algorithms. For example, for rules-based analyses, responses can be grouped into categories based on rules relating to keywords used in a free response or selection of pre-articulated choices, and those categories may be qualitative or quantitative. LLM-based analyses may involve computer-generated categorization through the LLM's summarization abilities. Other ML-based analyses may use vectors between a candidate's input and the inputs and outputs related to other people to determine an output for the candidate (the outputs, like categories, can be quantitative or qualitative).

The index score generated by the system, regardless of the type of data input for generating the score, is quantitative (i.e., numerical). In some embodiments, the index score is on a scale from 1 to 100. In some embodiments, the index score is on a scale from 1 to 850. The score may be generated through rules or through ML algorithms (which may include LLMs). In a simple embodiment, a person's index score may simply be their percentile score based on a uniform multiple-choice questionnaire presented to candidates.

Rules-based generation of an index score may involve allocating part of the total available score between categories. For example, for a maximum score of 100, 10 may be allocated to education, 20 allocated to job experience, 30 to a candidate's reference, and 40 to a candidate's personality characteristics. If a candidate has a bachelor's degree, that may be 7 points out of 10 in the education category; if he has 18 years of experience, that may be an 18 out of 20 in the job experience category; if his reference is a CEO of a large company but only has two years of experience with the candidate, that may be a 14 our of 30 in the reference category, and if the candidate scored in the 50th percentile in responses to a questionnaire, that may be a 20 out of 40 in the personality category: giving the candidate a total index score of 59 out of 100.

Supervised-ML-based generation of an index score may be based on a neural net with weights adjusted based on inputs and outputs of other people. For example, a model may be trained based on inputs of both numerical and non-numerical data relating to other people, and outputs of scores that an evaluator would assign those people based on that input data. The model may guess weights for different nodes of the model to find local maxima or minima (with values from zero to one for each node) based on the sample of inputs and outputs, and then may guess a new output based on a new candidate's input data. The model may continue to be trained by having a person confirm, reject, or alter the score generated for the new candidate, and presenting that feedback to the model. LLMs may be used to assist in this process based on improved abilities to summarize and analyze free-response information over other ML algorithms.

The flowchart 200 proceeds to step 230 with storing a candidate profile in a database associated with the platform, where the candidate profile includes the information and scores related to the candidate. A candidate profile may be stored in the database so that some or all of the information related to that candidate can be retrieved for presentation to an employer or for further assessment. In some embodiments, a candidate profile comprises background information, purpose information, and an index score. In some embodiments, at least some information stored in a candidate profile may be kept confidential and not presented on a public-facing webpage (or otherwise made accessible to third parties). In some embodiments, at least some of the information in a candidate profile is presented to employers or to other candidates.

The flowchart 200 proceeds to step 240 with receiving employer information, where that employer information contains one or more characteristics of the employer. The employer information may comprise information similar to the candidate's purpose information. The employer information may relate to an employer's company culture, its core values, or what characteristics it values in employees. The employer information may be derived from a purpose statement, responses to a questionnaire, or similar mechanisms. The employer information may be derived from feedback left from employees or prior employees of the employer, surveys relating to the employer's reputation, or similar mechanisms. For example, MIT Sloan Management Review publishes a “Culture 500” report, which describes the culture of 500 companies, and employer information can be derived from that information. Glassdoor, Inc., and other companies also provide information about culture of companies. In some embodiments, the platform may retrieve information from external databases, such as from Glassdoor, Inc., and may store that information in association with companies in a database associated with the platform. Employer information may be received directly from the employer, or may be received from third parties. An example of employer information includes that an employer expects employers to work long hours, and to come into the office, but provides exceptional training to new employees: this may be considered as being three characteristics of the employer. As with candidate's purpose information, employer information may be quantitative or qualitative, and may be categorized with assistance from LLMs or other types of ML models.

The flowchart 200 proceeds to step 250 with storing, in the database, an employer profile corresponding to the employer and containing the employer information. The employer profile may include the employer's name, locations, job openings, logo, employer information, or other data relating to the employer. In some embodiments, at least some information stored in an employer profile may be kept confidential and not presented on a public-facing webpage (or otherwise made accessible to third parties). In some embodiments, at least some information stored in an employer profile is presented to candidates or to other employers.

The flowchart 200 proceeds to step 260 with generating, based on the candidate's purpose information and the employer information, a purpose-alignment score. A purpose-alignment score, unlike an index score, is an employer-dependent score for a candidate. The purpose-alignment score may be a measure of similarity between a candidate's purpose information and the employer's employer information. The purpose-alignment score is represented as a number, which may be expressed as a whole number or a percentage. The purpose-alignment score may be derived through an ML model that is trained on scores and information for other employer-candidate combinations. The purpose-alignment score may be derived through similarity vectors between purpose information and employer information. The purpose-alignment score may be derived through a rules-based approach: for example, by comparing values for the candidate and employer in categories like how much they value coming into the office or workplace trainings. Approaches for deriving a purpose-alignment score may be based on keywords used in purpose statements or in response to questionnaires.

Generating the purpose-alignment score may be performed in response to a signal. For example, the platform may generate the purpose-alignment score for a candidate-employer combination in response to receiving employer information, storing employer information, receiving purpose information, or storing purpose information. The platform may generate the purpose-alignment score based on a time schedule, such as once per day. The platform may generate the purpose-alignment score in response to a request by an employer, such as a request by the employer to receive more information about a candidate. The platform may generate the purpose-alignment score in response to a request by a candidate, such as a request by a candidate to apply to a job posting of an employer. The platform may generate the purpose-alignment score while generating a team of candidates, based on a candidate's index score or other characteristics being satisfactory for a role on the team. The generating of the purpose-alignment score may be performed based on the candidate's index score exceeding a threshold. The generating of the purpose-alignment score may be performed based on the candidate appearing in search results from a search performed by the employer.

The flowchart 200 proceeds to step 270 with presenting, to the employer, the index score and the purpose-alignment score. In some embodiments, the platform may elect to only present one of the two scores. Presenting the scores to the employer may be based on a stimulation: for example, it may be presented based on a request by the employer for more information about a candidate, based on a request by the employer to generate a team of candidates of which the candidate may be part of, based on a characteristics of a candidate matching a job posting of the employer, or may be based on a request by the candidate to apply to a role of the employer. Presenting the scores to the employer may allow the employer to select a candidate for a role more quickly based on numerical representations of characteristics being easier to grasp than pages of specific information about a candidate. In some embodiments, the employer may be able to request more information about a candidate, after seeing the candidate's scores, such as by clicking on a link associated with the candidate; and more information about a candidate may include resume-type information or a personal statement.

The flowchart 200 proceeds to step 280 with receiving, from the employer, a request to connect with the candidate. The request to connect may be based on the employer deeming that the index score or purpose-alignment score for the candidate is satisfactory. The request to connect may be based on the employer viewing more about the candidate after viewing the candidate's index score or purpose-alignment score. An employer's request to connect may include a request to schedule an interview with the candidate, a request to hire a candidate for a position with the employer, or a request to send a message to the candidate about a job with the employer.

The flowchart 200 proceeds to step 290 with providing an Internet-based communication channel between the employer using a first user device and the candidate using a second user device. The communication channel may be a mechanism for sending messages or documents between the candidate and the employer. The communication channel may be a mechanism for scheduling an interview or hosting an interview between the employer and the candidate. For example, in response to an employer indicating it wants to proceed with a candidate at step 280, the platform may indicate to the candidate that such interest by the employer exists; then the platform may present to the candidate an option to schedule an interview with the employer based on the employer's calendar availability; then the platform may set a meeting between the candidate and employer based on a response from the candidate. In some embodiments, setting up a meeting between the candidate and employer may be deemed a communication channel. In some embodiments, the platform may host a video interview between the parties. In some embodiments, the platform may provide a link to a third-party service for hosting a video interview between the parties. In some embodiments, an ability to send online messages between the candidate and employer may be deemed a communication channel.

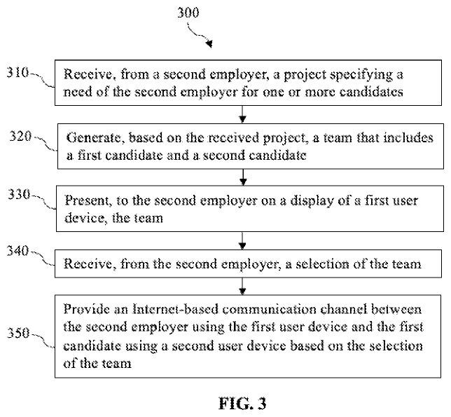

FIG. 3 is a flowchart 300 of steps performed by the platform in various embodiments of the invention. The flowchart 300 relates to presenting, to one employer, a team comprising at least two candidates, where one of the candidates is already employed by another employer. This may be related to a service that may be referred to as EGTOS (experienced global team of specialists).

The flowchart 300 begins at step 310 with receiving, from a second employer, a project specifying a need of the second employer for one or more candidates. An employer may have one or more projects. A project may include one or more tasks that need to be completed in furtherance of one or more goals of the employer. For example, if an employer wishes to create a smartphone app, the employer may provide a project to the platform specifying a need for a senior software engineer, a junior software engineer, and a marketing person, where at least one of the software engineers has experience with front-end development, and at least one of the software engineers has experience with back-end development.

The project may specify the candidates needed directly or indirectly. For example, the project may specify just that a smartphone application needs to be created within six months and that the employer already has a marketing person, so the platform would be able to infer (perhaps through an ML algorithm or a rules-based determination) that the employer needs two software engineers.

The project may also specify a budget, a timeline, or other characteristics of the project. The project may also list preferences of the employer, such as whether the candidates need to come into the office, whether they need to be on a certain range of time zones, or whether they need to speak a particular language.

The flowchart 300 continues to step 320 with generating, based on the received project, a team that includes a first candidate and a second candidate. The selection of candidates for the team may be based on an ML or rules-based algorithm. The generating may be based on a large pool of potential candidates, such as 100 candidates, 10,000 candidates, or a million candidates. The generation may include selecting candidates whose skills will complement each other: for example, if one engineer is experienced with front-end development and another engineer is experienced with back-end development, selecting those two candidates. The generation of a team may include allocating time between selected candidates: for example, based on hourly rates of the candidates or an estimation of the amount of time needed to complete tasks attributable to those candidates. The generation may be based on a project budget, tasks associated with the project, a timeline of the project, or skills needed to complete the project. The generation may be based on preferences of an employer, such as having at least one candidate present in the office, while other candidates may be remote or geographically distributed: some employers may wish to have a senior-level candidate in the office, but be lenient with junior-level candidates who may work under the senior-level candidate. The generation may be based on an index score or a purpose-alignment score for at least one candidate.

The generation may include optimization for one or more factors. For example, the one or more algorithms associated with the generation may ensure requirements for a project are met, such as requirements for budget, timeline, or geographic location of candidates, while also maximizing skillset of candidates of the team or candidates with particular roles on a team. The algorithm may also minimize cost of the team to satisfy a project, may maximize purpose-alignment scores of candidates, or may maximize index scores of candidates.

In some embodiments, purpose-alignment scores may be generated between candidates selected for a team (or being evaluated for selection on a team) to help ensure—in addition to the candidates' skillsets being complementary—that the candidates would be compatible from a cultural, personality, or motivational perspective. In some embodiments, the generation of a team for the project may comprise generating more than one team for the project.

The flowchart 300 continues to step 330 with presenting, to the second employer on a display of a first user device, the team. This presentation may be through a mobile-phone application, a webpage on an Internet browser, or through an email message. The presentation may include the names of the candidates, the index scores of the candidate, the purpose-alignment scores of the candidates, the locations of the candidates, the roles of the candidates, the hourly rates of the candidates, or other information about the candidates. In some embodiments, the platform may allow the employer to view more information about the candidates, such as through clicking a link associated with a candidate on the proposed team. In some embodiments, the presentation of a team may comprise presenting more than one proposed team so that the employer can choose between options for teams rather than just being able to select the team or not select the team. In some embodiments, the format for presenting the team includes an option for the employer to substitute one candidate on a team for a different candidate, to remove a candidate from a team altogether, or to request that additional candidates be added to a team. In some embodiments, the employer is able to provide feedback to the algorithm to improve a later generation of a team.

The flowchart 300 continues to step 340 with receiving, from the second employer, a selection of the team. This selection of a team may be a yes-or-no option. This selection may be a selection of the team over the selection of other potential teams. This selection may be an indication that the proposed team is satisfactory at a preliminary level, and that the employer may wish to interview the included candidates. This selection may be indicated through clicking a link on the platform that is associated with the team. In some embodiments, the second employer hires the first candidate on a contract basis and only for the project, and when that project ends, a relationship between the first candidate and the second employer concludes. In some embodiments, a relationship between the second employer and the second candidate persists after the completion of the project.

The flowchart 300 continues to step 350 with providing an Internet-based communication channel between the second employer using the first user device and the first candidate using a second user device based on the selection of the team. This step may confirm that the employer is proceeding with the selected team, or that the employer is employing the candidate associated with the first employer. The communication channel may be used for interviewing the candidates or for on-boarding the candidates to the project. The communication channel may be one-on-one between the employer and each candidate, or may group the communications such that both candidates and the employer can send messages to each of the other candidates in one dialogue. The communication channel may allow the candidates and employer to send messages or documents relating to tasks for the project. In some embodiments, the first candidate and the second candidate can communicate with each other in the communication channel.

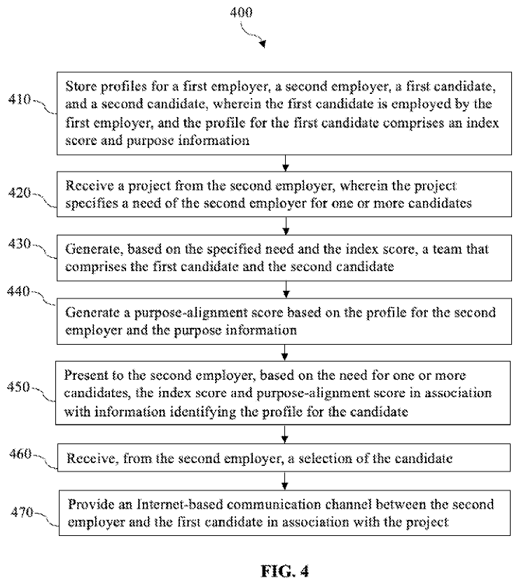

FIG. 4 is a flowchart 400 of steps performed by the platform in various embodiments of the invention. The flowchart 400 relates to generating a team of candidates for an employer's project based on an index score of a candidate already employed by a different employer. The flowchart 400 may include components from both of the prior flowcharts, 200 and 300, including both EGTOS and scores.

The flowchart 400 begins at step 410 with storing profiles for two candidates and two employers, where the first candidate is employed by the first employer, and the first candidate's profile includes an index score and purpose information. In some embodiments, the second candidate is employed by the second employer. In some embodiments, the second candidate's profile also comprises an index score or purpose information. The stored candidate profiles may be similar to the candidate profile stored in step 230. The stored employer profiles may be similar to the employer profile stored in step 250.

The flowchart 400 continues to step 420 with receiving a project from the second employer, wherein the project specifies a need of the second employer for one or more candidates. This step may be similar to step 310.

Flowchart 400 continues to step 430 with generating, based on the specified need and the index score, a team that comprises the first candidate and the second candidate. This step may be similar to step 320.

The flowchart 400 continues to step 440 with generating a purpose-alignment score based on the profile for the second employer and the purpose information. This step may be similar to step 260.

The flowchart 400 continues to step 450 with presenting, to the second employer, based on the need for one or more candidates, the index score and purpose-alignment score in association with information identifying profile for the candidate. This step may be similar to step 270.

The flowchart 400 continues to step 460 with receiving, from the second employer, a selection of the candidate. This step may be similar to step 340 or step 280.

The flowchart 400 continues to step 470 with providing an Internet-based communication channel between the second employer and the first candidate in association with the project. This step may be similar to step 290 or step 350.

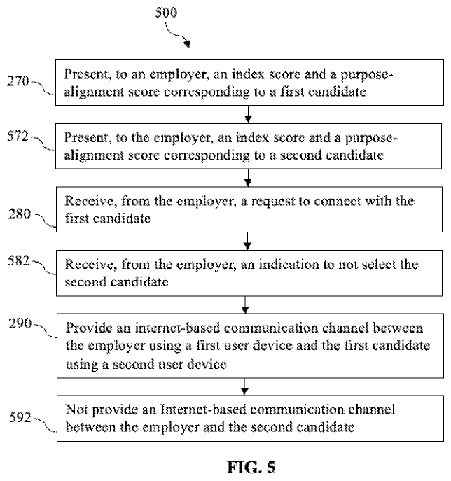

FIG. 5 is a flowchart 500 of steps performed by the platform in various embodiments of the invention. The flowchart 500 relates to an employer selecting between two candidates based on index and purpose-alignment scores of the candidates. The flowchart 500 adds to the flowchart 200 steps of (572) presenting, to the employer, index and purpose-alignment scores related to the second candidate; (582) receiving, from the employer, an indication to not select the second candidate; and (592) not providing an Internet-based communication channel between the employer and the second candidate.

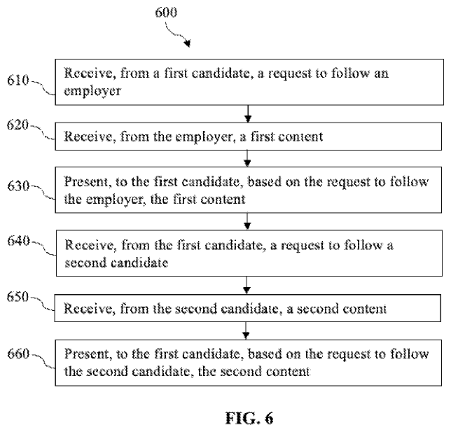

FIG. 6 is a flowchart 600 of steps performed by the platform in various embodiments of the invention. The flowchart 600 relates to sharing content between users of the platform.

The flowchart 600 begins at step 610 with receiving, from a first candidate, a request to follow an employer. A request to follow an employer may include a button on a public-facing portion of the employer's profile. A request to follow may include a request to be included in the employer's network, to be notified of updates related to the employer, or to include updates related to the employer in a generated news feed for the subscribing candidate. An update may include a change to the employer's job postings. An update may include content, such as images or text, that an employer wishes to share with subscribers.

The flowchart 600 continues to step 620 with receiving, from the employer, a first content. The first content may be an update by the employer. The first content may include text, images, or video. Content provided by the employer may appear on the employer's profile, or may be used to generate employer information.

The flowchart 600 continues to step 630 with presenting, to the first candidate, based on the request to follow the employer, the first content. In some embodiments, a request to follow may be approved automatically or through an indication by the employer. Presenting may include displaying the content on the candidate's user device (e.g., a smart phone or computer). Presenting may include in a news feed generated for the candidate by the platform.

The flowchart 600 continues to step 640 with receiving, from the first candidate, a request to follow a second candidate. This request to follow a candidate may be similar to the request to follow an employer in step 610.

The flowchart 600 continues to step 650 with receiving, from the second candidate, a second content. This step to receive content from a candidate may be similar to receiving content from an employer in step 620.

The flowchart 600 continues to step 660 with presenting, to the first candidate, based on the request to follow the second candidate, the second content. This step to present content from a candidate may be similar to presenting content from an employer in step 630.

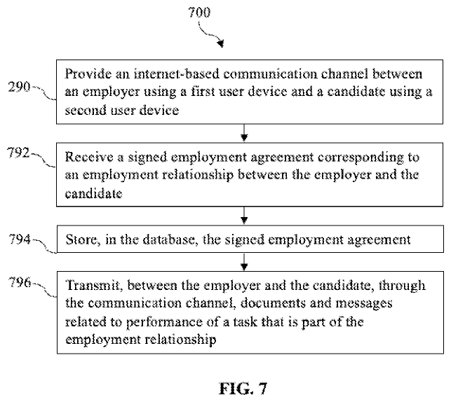

FIG. 7 is a flowchart 700 of steps performed by the platform in various embodiments of the invention. The flowchart 700 relates to receiving an employment agreement between the employer and candidate, and transmitting information between those parties in relation to them carrying out that agreement.

The flowchart 700 begins at step 290 with providing an Internet-based communication channel between an employer using a first user device and a candidate using a second user device.

The flowchart 700 continues to step 792 with receiving a signed employment agreement corresponding to an employment relationship between the employer and the candidate. The received employment agreement may be submitted to the platform by one of the parties, may be signed within the platform, or may be received from a third-party application through an API. Receiving the signed employment agreement may indicate that the candidate and employer have an employment arrangement such that further communications between the parties may be in furtherance of completing tasks associated with the arrangement rather than in establishing an employment arrangement.

The flowchart 700 continues to step 794 with storing, in the database, the signed employment agreement. The signed agreement may be stored such that the parties may later view or download the agreement through the platform's interface.

The flowchart 700 continues to step 796 with transmitting, between the employer and the candidate, through the communication channel, documents and messages related to performance of a task that is part of the employment relationship. Such documents and messages may include, for example, delegation of tasks, questions about how to carry out a task, documents describing the tasks, or completed work product for the tasks. An employment relationship may include one or more tasks, and may be based on one or more projects that encompass one or more tasks. A project may be, for example, creating an application for a mobile phone, and a task may be, for example, creating a particular set of pages or functionality for that application. In some embodiments, the documents may include Word files, PDFs, or source code files, or links to a third-party service containing such files.

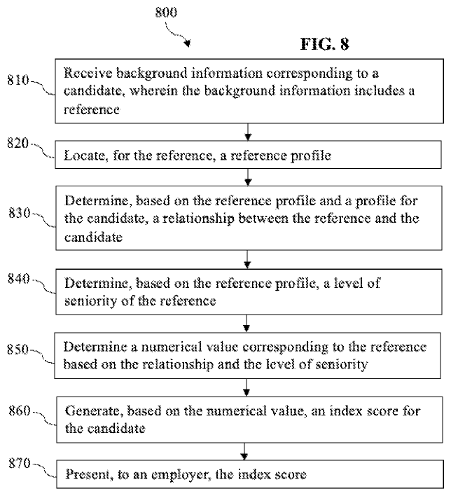

FIG. 8 is a flowchart 800 of steps performed by the platform in various embodiments of the invention. The flowchart 800 relates to generating an index score based on an assessed significance of a candidate's reference.

The flowchart 800 begins at step 810 with receiving background information corresponding to a candidate, wherein the background information includes a reference. The reference is a person who can vouch for the candidate. The reference may be able to provide, or has provided, information about the candidate, such as the candidate's character, the candidate's ability to perform a job, or that the candidate's background information is accurate.

The flowchart continues to step 820 with locating, for the reference, a reference profile. The reference profile may be stored in the database of the platform, or may be located on a third-party service, such as the service provided by LinkedIn Corporation. The reference profile may include information about the reference that includes the reference's current and former job titles and companies, and the years employed for each.

The flowchart continues to step 830 with determining, based on the reference profile and a profile for the candidate, a relationship between the reference and the candidate. Determining a relationship may be rules-based or based on an ML model (such as an LLM model). The platform may compare the candidate's years of employment at companies with the reference's employment to find overlap. For example, if the candidate was employed at company A from 2009 to 2013 as an associate, and the reference was employed at company A from 2011 to 2016 as a manager, then the platform may determine that the reference was the candidate's boss for two years at company A.

The flowchart continues to step 840 with determining, based on the reference profile, a level of seniority of the reference. A level of seniority may be a binary determination of more senior or not more senior than the candidate. A level of seniority may be on a numerical scale, such from one to ten. A level of seniority may be qualitative, such as a CEO, a mid-level manager, or an associate. A level of seniority may have relevance based on how influential the person is, how much the person oversaw the candidate's work, or how likely the reference is to provide truthful information about the candidate. In some embodiments, the platform determines a level of seniority through ML models, such as LLM models, that can characterize the contents of the reference's profile or otherwise provide a category or number association between the reference's profile information and the reference's level of seniority.

The flowchart continues to step 850 with determining a numerical value corresponding to the reference based on the relationship and the level of seniority. The numerical value corresponding to the reference may take into account the reference's relationship with the candidate and the level of seniority of the reference, which may each be numerical or qualitative characteristics. The numerical value corresponding to the reference may be derived through rules-based algorithms, or through application of ML models.

The flowchart continues to step 860 with generating, based on the numerical value, an index score for the candidate. This step may be similar to step 220. This step 860 involves accounting for the numerical value of the reference in generative the index score. This determining step can be rules-based or ML-based, as with step 220. An example of a rules-based solution is to allocate ten possible points to a references category, then assigning a value from one to ten based on the seniority and relationship. For example, if the reference is a CEO of a large company, that may be worth 5 points, and if the reference only indirectly oversaw the candidate's work and only for two years, that may be worth two points, for a total of seven points out of ten to contribute to the candidate's index score. In some embodiments, the numerical value may be used as part of the candidate's background check.

The flowchart continues to step 870 with presenting, to an employer, the index score. This step may be similar to step 270.

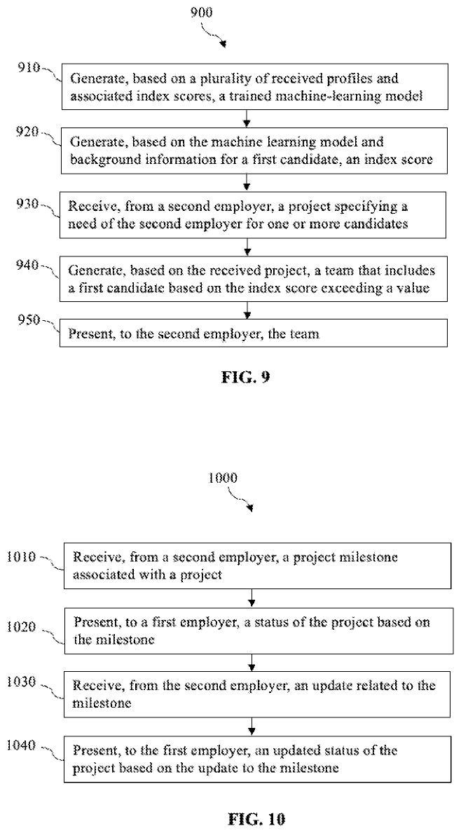

FIG. 9 is a flowchart 900 of steps performed by the platform in various embodiments of the invention. The flowchart 900 relates to using an ML model to generate an index score, where that index score is used to generate a team of candidates for an employer's project.

The flowchart 900 begins at step 910 with generating, based on a plurality of received profiles and associated index scores, a trained machine-learning model. The machine learning (ML) model may be selected from any of the ML algorithms known to those of skill in the art. The training may be based on supervised, where both inputs (e.g., background information stored in a profile) and outputs (e.g., scores) of the training data are included. A trained model has weights assigned to nodes of the neural network based on the training data.

The flowchart 900 continues to step 920 with generating, based on the machine learning model and background information for a first candidate, an index score. This step applies the ML model to a candidate's background information to have the machine-learning model derive and output an index score.

The flowchart 900 continues to step 930 with receiving, from a second employer, a project specifying a need of the second employer for one or more candidates. This step may be similar to step 310.

The flowchart 900 continues to step 940 with generating, based on the received project, a team that includes a first candidate based on the index score exceeding a value. This step may be similar to steps 320 and 430. This step requires a minimum index score for candidates selected as part of a team. The minimum score may be set by the employer or by the platform itself. For example, the platform may offer the employer an option to filter candidates available for the team by the index scores.

The flowchart 900 continues to step 950 with presenting, to the second employer, the team. This step may be similar to step 330. The team may be displayed, on the employer's user device, as a list of candidates who may work together on the project.

FIG. 10 is a flowchart 1000 of steps performed by the platform in various embodiments of the invention. The flowchart 1000 relates to keeping an employer updated with the status of another employer's project, which is particularly relevant when employers share employees.

The flowchart 1000 begins at step 1010 with receiving, from a second employer, a project milestone associated with a project. A project may have one or several milestones. A milestone may be the completion of a task or the completion of a stage of the project (e.g., alpha, beta, etc.). A milestone may be an indicator for how much of the project is completed or remaining.

The flowchart 1000 continues to step 1020 with presenting, to a first employer, a status of the project based on the milestone. A status may include an indication that a milestone has been completed. A status may include a representation of how many milestones are completed and how many are remaining, for a project or for a candidate. In some embodiments, two or more milestones may be presented on a timeline, and a status may indicate the location of the project on that timeline. In some embodiments, a status may be presented as a percentage.

The flowchart 1000 continues to step 1030 with receiving, from the second employer, an update related to the milestone. The update may be that the milestone has been completed. The update may be that the milestone is partly completed. The update may be that the milestone has been removed from the project. The updated status is a new status that takes into account the change to the milestone. For example, if the second employer marks the milestone as complete, the status of the milestone may be represented as a checkmark beside a name for the milestone, may be represented on a timeline with other milestones, or may be represented as a percentage based on the number of milestones completed and the number of milestones remaining. A percentage may be represented as a number or as a graphical representation such as a partially-filled bar.

The flowchart 1000 continues to step 1040 with presenting, to the first employer, an updated status of the project based on the update to the milestone. Presenting the updated status to the first employer may be particularly relevant where a candidate on the project is primarily employed by the first employer, and the first employer needs a better idea of the amount of bandwidth the candidate has or may have in the future. For example, the first employer may want to staff the candidate on another project as soon as the candidate's project for the second employer concludes. Presenting the status may be on a display screen of a user device of the first employer.

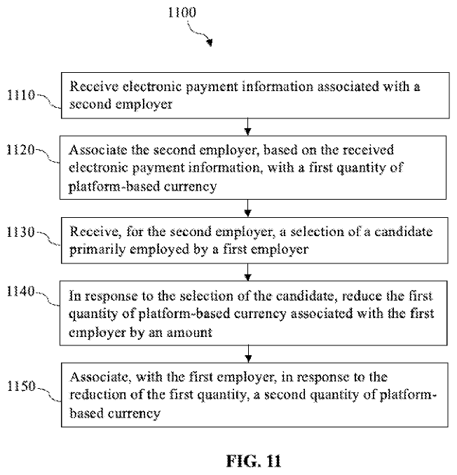

FIG. 11 is a flowchart 1100 of steps performed by the platform in various embodiments of the invention. The flowchart 1100 relates to enhancing the ability of employers to exchange resources on a platform by using a platform-based currency and allowing employers to pay each other for the use of the other's employee.

The flowchart 1100 begins at step 1110 with receiving electronic payment information associated with a second employer. The electronic payment information relates to a transfer, from the second employer to the platform, of funds in one or more types of currency. The electronic payment information may be transferred funds, or a receipt of transferred funds, between the second employer and the platform. The electronic payment information may be credit card information, bank wire information, or a public key (for cryptocurrencies), accompanied by a request to transfer a designated amount of that currency between the second employer and the platform. The purpose of receiving payment information is to get funds on the platform to be associated with the second employer.

The flowchart 1100 continues to step 1120 with associating the second employer, based on the received electronic payment information, with a first quantity of platform-based currency. This is a conversion of non-platform-based currency with platform-based currency. The non-platform-based currency may be transferred into a bank account associated with the platform, and the platform-based currency may be of a quantity calculated based on a dynamic exchange rate between currency types. For example, an employer may be able to add 200 tokens (platform currency) to its account by adding 200,000 USD to the platform. Another employer may add 100 tokens to his account through another type of currency, such as BTC, ETH, CNY, CAD, EUR, CHF, or GBP, which may each have exchange rates to USD that changes frequently with time. The association of currency may be stored with the employer's profile, and may be presented to the employer when the employer views his profile page (a page that may present some or all of the employer's profile information).

The flowchart 1100 continues to step 1130 with receiving, for the second employer, a selection of a candidate primarily employed by a first employer. This may be similar to step 460 or step 280.

The flowchart 1100 continues to step 1140 with, in response to the selection of the candidate, reduce the first quantity of platform-based currency associated with the first employer by an amount. This reduction in funds by the second employer rejects a payment of the second employer for the services of the candidate. This may be performed immediately upon selecting to hire the candidate, or may be performed after the candidate has begun or completed his work on the project. Timing of payment may be implementation-specific and based on the desire or agreement of the employers or the candidates.

The flowchart 1100 continues to step 1150 with associating, with the first employer, in response to the reduction of the first quantity, a second quantity of platform-based currency. The first employer is paid for providing excess time of his employee to the second employer. This step reflects that at least some of the payment by the second employer is received by the first employer. In some embodiments, the candidate does not directly receive any of the funds reduced from the second employer's account. In some embodiments, all of the funds reduced from the second employer's account are transferred to the first employer's account. In some embodiments, the difference between the first quantity and the second quantity is retained by the platform as revenue for the platform.

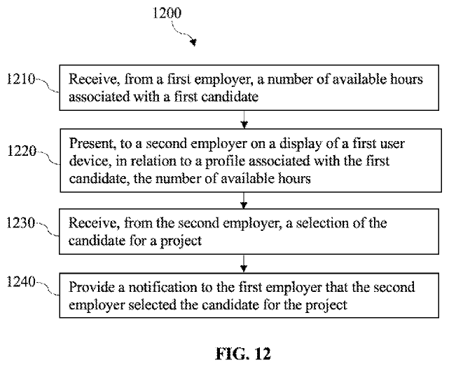

FIG. 12 is a flowchart 1200 of steps performed by the platform in various embodiments of the invention. The flowchart 1200 relates to presenting an availability of a candidate as a hiring criterion for an employer, where that availability may be based on the candidate being primarily employed by another employer.

The flowchart 1200 begins at step 1210 with receiving, from a first employer, a number of available hours associated with a first candidate. If the first candidate is primarily employed by the first employer, and has excess capacity (i.e., free time), the first employer may elect to provide the first candidate to a second employer to help with the second employer's projects as a contractor to fill that excess capacity and keep the first candidate busy and productive. The first employer may know the number of hours of excess capacity the first candidate has across a period of time (e.g., during a fiscal quarter, a month, a week, or per day), either short-term, long-term, or indefinitely, and may wish to sell that time to a second employer.

The flowchart 1200 continues to step 1220 with presenting, to a second employer on a display of a first user device, in relation to a profile associated with the first candidate, the number of available hours.

The flowchart 1200 continues to step 1230 with receiving, from the second employer, a selection of the candidate for a project. This may be similar to steps 280, 340, or 460. The selection of the candidate may be an indication that the candidate is hired for the project, which may come after an interview of the candidate by the second employer, which may be held through the platform or a third-party service linked through the platform.

The flowchart 1200 continues to step 1240 with providing a notification to the first employer that the second employer selected the candidate for the project. This notification may be on a display device of the first employer. This notification may be within the platform's user interface, or may be presented outside the platform, such as through email. This notification may be accompanied by a payment from the second employer of platform-based currency. This notification may be accompanied by a status of the project, or a set of milestones associated with the project, that the first candidate is assigned to. This notification may indicate a number of hours (such as total hours, or hours per week) that the first candidate will (or likely will) be occupied by the second employer on the project.

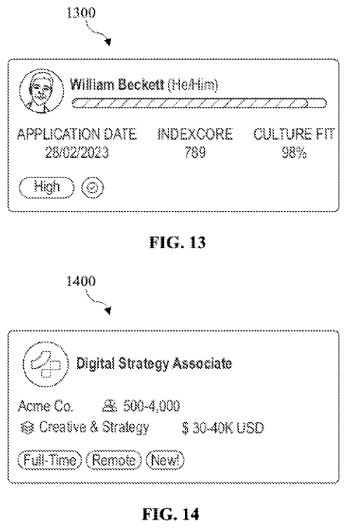

FIG. 13 is a diagram 1300 that depicts a candidate profile as may be seen by an employer. This depiction of a candidate profile may be what an employer sees when presented with a candidate. As seen, this example view of a candidate profile is for a candidate named William Beckett. This depiction of a candidate profile may be the public-facing portion of the candidate's profile, and may be less than all of the information stored in the candidate's profile. In some embodiments, an employer may be able to click within the depiction of the candidate profile to see more information about the candidate, such as the candidate's detailed employment and educational histories, or the candidate's biography or personal statement. As shown, this depiction of a candidate profile includes a culture fit of 98%. The “culture fit” is another term for “purpose-alignment score” in this context, and may be generated for the employer who this depiction of the candidate profile is presented to. This depiction of a candidate profile also shows an indexcore (another term for “index score”) of 789, which may be on a scale between 0 and 850. The diagram 1300 also shows an application date, which may be the date the candidate applied to the employer who this depiction of the candidate profile was generated for. The diagram 1300 also includes a check mark, which may indicate that the candidate has been verified, that the candidate passed a background check, or that the candidate is authorized to work in the employer's geographical location (e.g., in the U.S.).

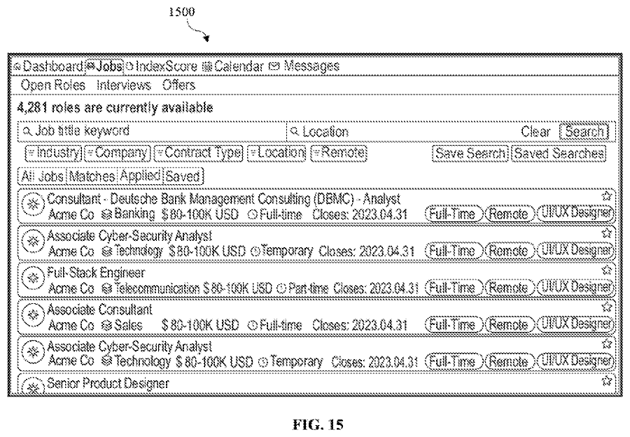

FIG. 14 is a diagram 1400 that depicts a job posting as may be seen by a candidate. As seen, the job posting includes a salary range listed in USD. In some embodiments, the salary range may be in other currencies, such as a platform currency. For example, the platform may present the salary in the candidate's preferred currency type, by the platform converting from a platform to such currency type through an exchange rate, and may re-convert the currencies based on exchange rates in real time, upon request, or at specified time intervals. As seen, this job posting is for a full-time candidate, is remote (i.e., no in-office requirement), and is newly posted. As seen, the role is for “digital strategy associate,” the company is Acme Co, which is a company with between 500 and 4000 employees.

FIG. 15 is a diagram 1500 that depicts a set of job postings by an employer. This may be a view presented to a candidate. As seen, a candidate can filter the job postings by industry, company, contract type, location, whether or not it is remote, and by keyword. The candidate can also jobs the candidate matches with, has applied to, or has saved. As seen at the top, there are tabs for job postings, but also for a dashboard, an index score, a calendar, and messages. The messages may be a communication channel. Furthermore, the calendar may include interviews a candidate has with employers, which may also include communication channels for those interviews.

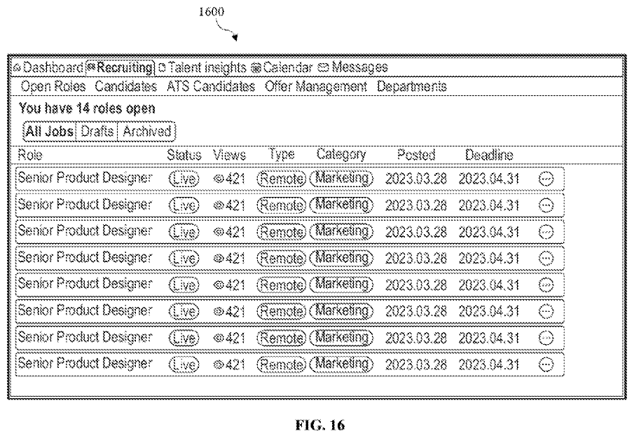

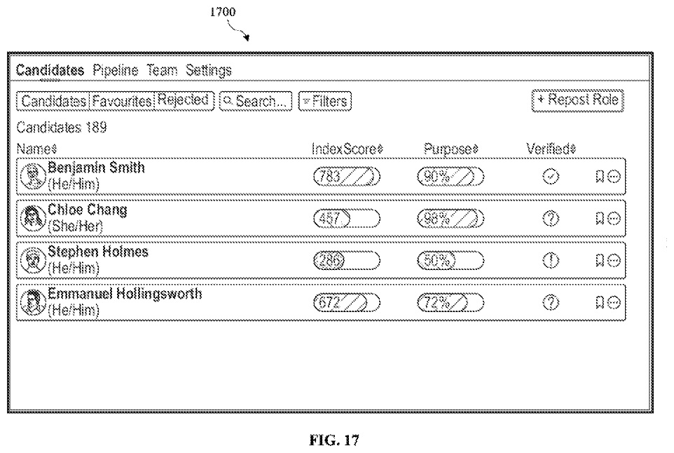

FIG. 16 is a diagram 1600 that depicts roles open for an employer. This may be a view presented to an employer. As seen, the tabs at the top include dashboard, recruiting, talent insights, calendar, and messages. “Talent insights” might be a computer-generated analysis of potential candidates and marketing efforts to those candidates. As seen, the employer has 14 active roles in which candidates can be recruited for (e.g., the candidates can apply to those roles).

FIG. 17 is a diagram 1700 that depict candidates presented to an employer. As seen, the candidates each have an index score and a purpose alignment score, represented both numerically and graphically (with shaded bars). As seen, the employer's view of candidates also includes search and filter options. This depiction of candidates presented to an employer may be candidates who have matched with or applied to a role posted by the employer.

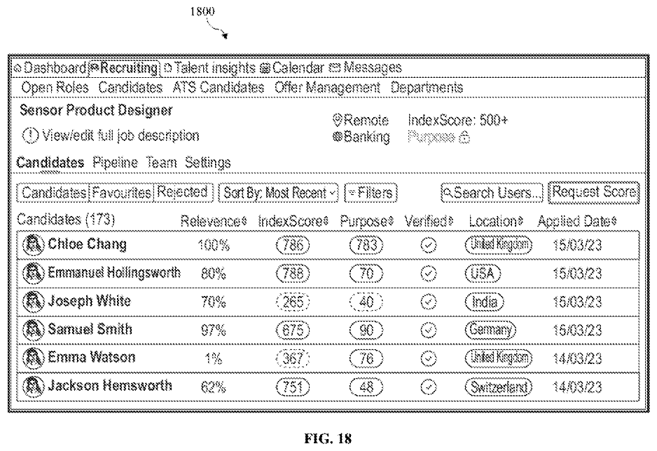

FIG. 18 is a diagram 1800 that depict candidates presented to an employer. As seen, these candidates are presented along with index scores, purpose-alignment scores, verification status, location, date the candidate applied to the employer's position, and a relevance score. The relevance score may be based on a comparison between the job posting's requirements and the candidate's experience. The relevance score may be based on a comparison between the candidate's profile information and a keyword search performed by the employer. In some embodiments, the purpose-alignment scores for candidates may be presented to the employer only upon a request by the employer, such request being indicated with a “request score” button. Requesting a score may apply to all candidates or may apply to only one or a selection of candidates.

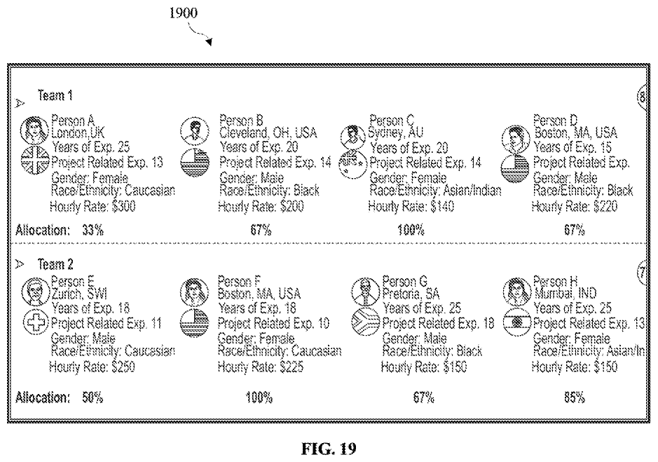

FIG. 19 is a diagram 1900 that depicts two teams generated by the platform. As seen, each team comprises four candidates, each with an allocation of hours, an hourly rate, a location, a number of years of experience and project-related experience. The candidates in the diagram 1900 are also each associated with a gender and a race/ethnicity. In some embodiments, the platform may recommend one of the generated teams over other generated teams. In some embodiments, an employer may be able to select one team over another team. The allocation may be a percentage of the candidate's time that is spent on the respective project.

1. A platform for connecting employers with candidates, the platform comprising:
a database storing a profile for a first employer, a profile for a second employer, a profile for a first candidate, and a profile for a second candidate, wherein:
the first candidate is employed by the first employer,
the second candidate is employed by the second employer, and
the profile for the first candidate comprises an index score and purpose information; and
one or more processors in communication with the database and two or more user devices, wherein the one or more processors perform the following steps:
receiving a project from the second employer, wherein the project specifies a need of the second employer for one or more candidates;
generating, based on the specified need and the index score, a team that comprises the first candidate and the second candidate;
generating a purpose-alignment score based on the profile for the second employer and the purpose information;
presenting to the second employer, based on the generated team, the index score and the purpose-alignment score in association with information identifying the profile for the first candidate;
receiving, from the second employer, a selection of the team; and
providing, based on the selection of the team, an Internet-based communication channel between the second employer and the first candidate in association with the project.

2. A platform for connecting employers with candidates, the platform comprising:
a database for storing one or more candidate profiles and one or more employer profiles; and
one or more processors in communication with the database and two or more user devices, wherein the one or more processors perform the following steps:
receiving background information and purpose information corresponding to a candidate;
generating an index score based on the received background information;
storing, in the database, a candidate profile corresponding to the candidate and containing the index score, the background information, and the purpose information;
receiving employer information containing one or more characteristics of the employer;
storing, in the database, an employer profile corresponding to the employer and containing the employer information;
generating, based on the candidate's purpose information and the employer information, a purpose-alignment score;
presenting, to the employer, the index score and the purpose-alignment score;
receiving, from the employer, a request to connect with the candidate; and
providing an Internet-based communication channel between the employer using a first user device and the candidate using a second user device.

3. The platform of claim 2 wherein the steps performed by the one or more processors further comprise:
presenting, to the employer, a second index score and a second purpose-alignment score, each corresponding to a second candidate;
receiving, from the employer, an indication to not select the second candidate; and
not providing an Internet-based communication channel between the employer and the second candidate.

4. The platform of claim 2 wherein the steps performed by the one or more processors further comprise:
receiving, from the candidate, a request to follow the employer;
receiving, from the employer, a content; and
presenting, to the candidate and based on the request to follow, the content.

5. The platform of claim 2 wherein the steps performed by the one or more processors further comprise:
storing a signed employment agreement corresponding to an employment relationship between the employer and the candidate, wherein the Internet-based communication channel facilitates the candidate's performance of a task as part of the employment relationship.

6. The platform of claim 2 wherein the Internet-based communication channel is used by the employer to interview the candidate.

7. The platform of claim 2 wherein the purpose-alignment score is generated based on similarity vectors between aspects of the purpose information and aspects of the employer information, and the index score is generated based on a machine-learning model.

8. The platform of claim 2 wherein the steps performed by the one or more processors further comprise:
receiving, from the employer, a project, wherein:
the project specifies a need of the employer for one or more candidates;
the presenting of the index score and purpose-alignment score to the employer is based on a match between the candidate profile and the need for one or more candidates; and
the Internet-based communication channel allows the employer and the candidate to send, between each other, one or more documents and messages that are related to the project.

9. The platform of claim 2 wherein the steps performed by the one or more processors further comprise:
performing a background check for the candidate, including an automated evaluation of a reference associated with the candidate profile, wherein the automated evaluation includes determining, from a profile associated with the reference:
a relationship between the reference and the candidate, and
a level of seniority of the reference.

10. The platform of claim 2 wherein:
the presenting of the index score and the purpose-alignment score to the employer is based on at least one of the index score and the purpose-alignment score, independently or in combination, exceeding a threshold value.

11. The platform of claim 2 wherein:
the generating of the purpose-alignment score is based on the index score exceeding a threshold, and at least one of the candidate applying for a position with the employer, or the employer requesting more information about the candidate.

12. A platform for connecting employers with candidates, the platform comprising:
a database storing a profile for a first employer, a profile for a second employer, a profile for a first candidate, and a profile for a second candidate, wherein the first candidate is primarily employed by the first employer; and
one or more processors in communication with the database and two or more user devices, wherein the one or more processors perform the following steps:
receiving, from the second employer, a project, wherein the project specifies a need of the second employer for one or more candidates;
generating, based on the received project, a team that includes the first candidate and the second candidate;
presenting, to the second employer on a display of a first user device, the team;
receiving, from the second employer, a selection of the team; and
providing an Internet-based communication channel between the second employer using the first user device and the first candidate using a second user device based on the selection of the team comprising the first candidate, wherein the communication channel allows the second employer and the first candidate to send, between each other, one or more documents and messages that are related to the project.

13. The platform of claim 12 wherein the second candidate is primarily employed by the second employer.

14. The platform of claim 12 wherein the steps performed by the one or more processors further comprise:
receiving, from the first candidate, a request to follow the second candidate;
receiving, from the second candidate, a content; and
presenting, to the first candidate and based on the request to follow, the content.

15. The platform of claim 12 wherein the steps performed by the one or more processors further comprise:
storing a signed employment agreement corresponding to an employment relationship between the second employer and the first candidate, wherein the Internet-based communication channel facilitates the first candidate's performance of a task as part of the employment relationship.

16. The platform of claim 12 wherein the Internet-based communication channel is used by the second employer to interview the first candidate.

17. The platform of claim 12 wherein:
the generating the team is based on a budget of the second employer, one or more requirements of the project, and one or more preferences of the second employer; and
the generating the team includes an allocation of time for the project between the first candidate and the second candidate.

18. The platform of claim 12 wherein the steps performed by the one or more processors further comprise:
receiving, from the second employer, a milestone associated with the project;
presenting, to the first employer, a status of the project based on the milestone not being completed;
receiving, from the second employer, an indication that the milestone is completed; and
presenting, to the first employer, an updated status of the project based on the completion of the milestone.

19. The platform of claim 12 wherein the steps performed by the one or more processors further comprise:
receiving electronic payment information associated with the second employer;
associating with the second employer, based on the received electronic payment information, a first quantity of platform-based currency;
in response to the selection of the team comprising the first candidate, reducing the first quantity of platform-based currency associated with the second employer by an amount; and
associating, with the first employer, a second quantity of platform-based currency, wherein the second quantity is less than or equal to the amount.

20. The platform of claim 12 wherein the steps performed by the one or more processors further comprise:
receiving, from the first employer, a number of available hours associated with the first candidate, wherein:
the presenting, to the second employer, of the team includes the number of available hours.
